(19) United States
(12) Patent Application Publication
(10) Pub. No.: US 2018/0292241 A1
(43) Pub. Date: Oct. 11, 2018

(54) CONSTRUCTION TEMPLATE

(71) Applicant: FRP PRODUCTIVITY INC., Edmonton (CA)

(72) Inventor: Roland Majeau, Edmonton (CA)

(21) Appl. No.: 15/804,498

(22) Filed: Nov. 6, 2017

Related U.S. Application Data
(60) Provisional application No. 62/484,133, filed on Apr. 11, 2017.

(51) Int. Cl. G01D 7/00

(52) U.S. Cl. CPC G01D 7/00

(57) ABSTRACT

An actual size construction template may be attached across a plurality of studs in a wall frame, and is marked with construction locations to indicate the installed locations of appliances and fixtures. The template is created from a scaled schematic construction plan.

### FIELD

The present invention relates to a template for residential or commercial construction.

### BACKGROUND

As is known in the construction industry, the “rough-in” stage of construction means that walls have been framed but are still open in that drywall or other wall coverings have not been attached yet. It is at the rough-in stage where electrical and plumbing sub-contractors would bore holes and install wires, pipes, boxes and the like.

The location of roughed-in electrical wires and boxes, and plumbing supply pipes and drain pipes is usually indicated on building plans which are drawn to scale. The tradesperson must then route and place items in accordance with the plans, which are schematic scale drawings. However, the plans may result in some ambiguities when considering the roughed-in construction. For example, a particular location may occur in the space between studs, and no physical mark can be made. Markings on the floor are sometimes used, but the floor space becomes dirty or cluttered with debris. As well, confusion can arise when different trades make their own marks.

Following the rough-in stage, wall covering material is installed. Occasionally, the roughed-in location of electrical boxes and plumbing locations do not match the actual plans, sometimes because of an error of a tradesperson.

There is a need in the art for a method and system for determining marking electrical and plumbing locations at a roughed-in stage of construction.

### SUMMARY

In one aspect, the invention comprises an actual size horizontal template which is configured to attach across a plurality of studs in a wall frame, and which is marked with construction locations, wherein said template is created from a scaled schematic plan. In one embodiment, the template comprises a rollable or foldable material.

In one aspect, the invention comprises an actual size horizontal template in combination with an actual size story vertical template configured to be attached to a stud vertically, and which is marked with construction locations. In one embodiment, the vertical template comprises a story rod or a rollable or foldable material.

In another aspect, the invention comprises a method of construction, comprising the steps of:

(a) producing an actual size template having location marking from a scaled schematic construction plan;

(b) attaching the template to a wall frame after framing is complete but before wall finishings are attached.

In one embodiment, the template is a horizontal template configured to be attached across a plurality of wall studs. In another embodiment, the template is a vertical template configured to be attached on a vertical wall stud. Preferably, both a horizontal and a vertical template are produced and used. Preferably, the template is a rollable or foldable material, such as paper, plastic or fabric sheeting.

### DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows conventional schematic construction plans.

FIG. 2 shows an embodiment of a horizontal template and a vertical template of the present invention.

FIG. 3 shows a horizontal template attached to a stub wall frame.

### DESCRIPTION

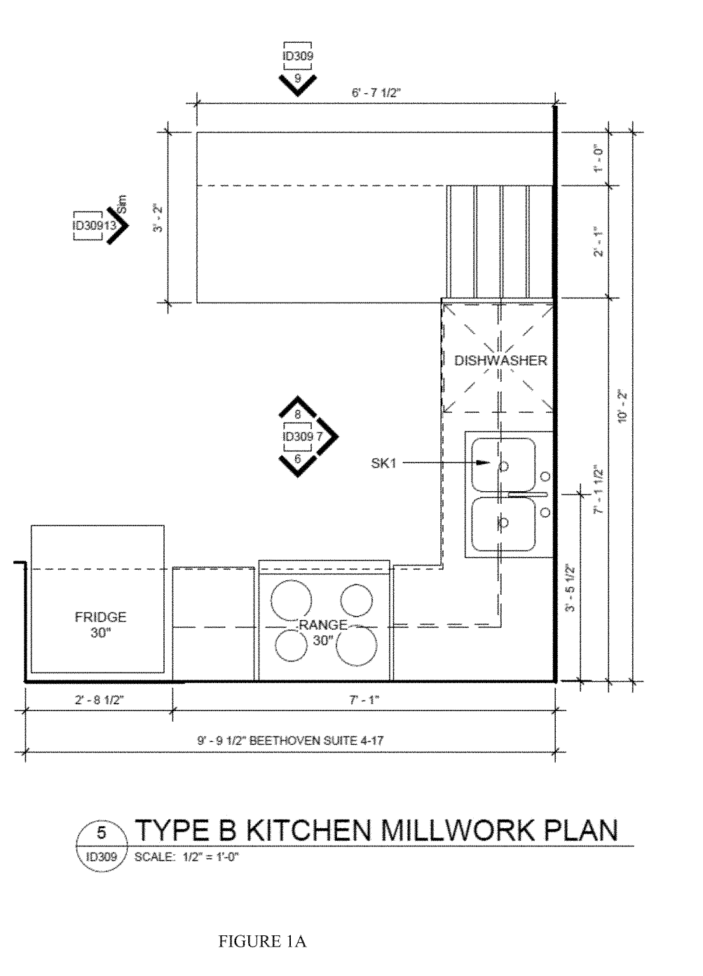

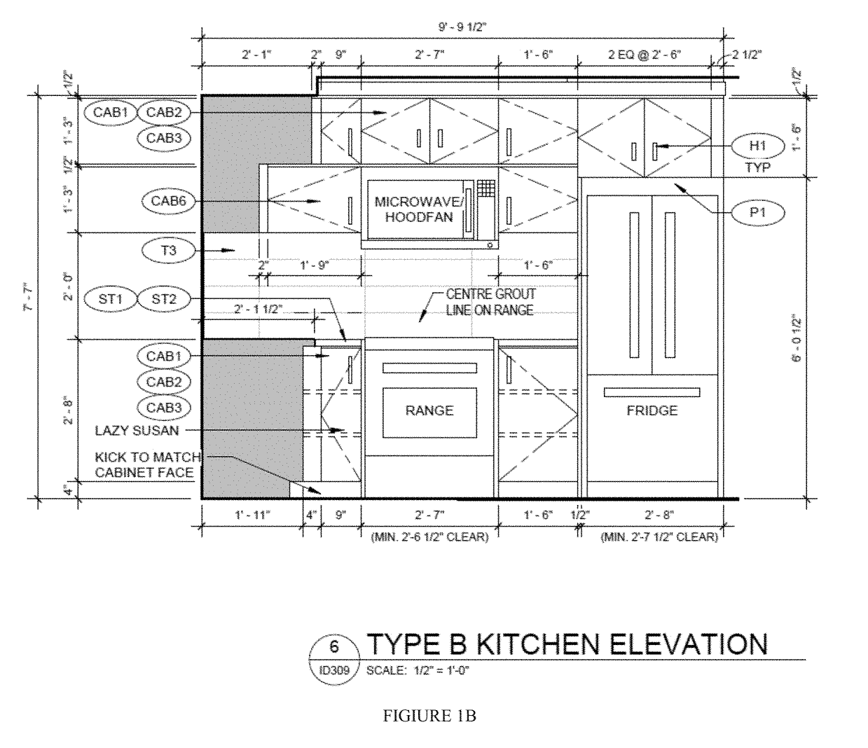

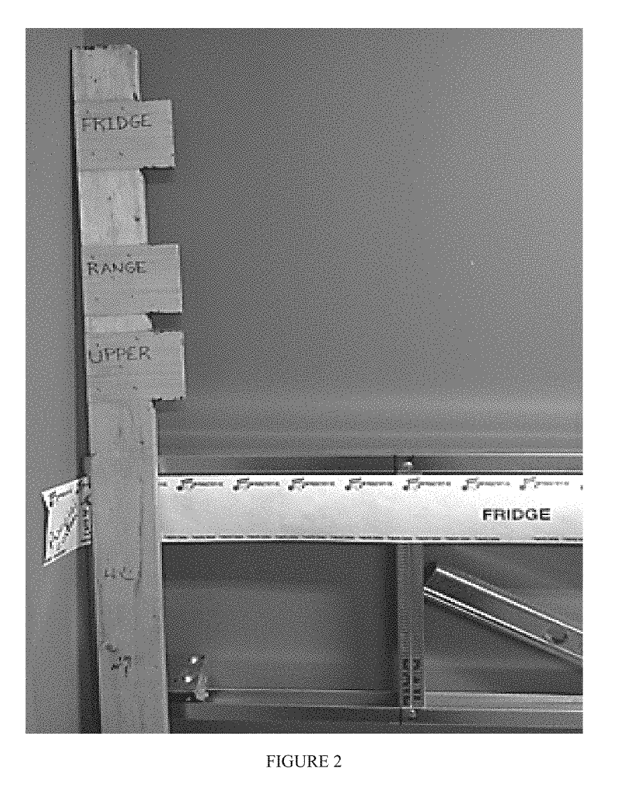

Conventional scale construction plans shown in FIG. 1 are of a kitchen. The top plan view shows the floor location of important kitchen appliances or fixtures. The elevation view shows the height of the various kitchen appliances or fixtures, as well as horizontal distances. As used herein, an appliance or fixture is an item which will later be installed which requires an electrical, plumbing or other installation. For example, a non-exhaustive list of appliances or fixtures may include conventional household appliances such as washers, dryers, ranges, stoves or cooktops, microwave ovens, range hoods, dishwashers, countertops, cabinetry, lighting fixtures, entertainment devices such as televisions or video monitors, computers, networking devices, home automation devices, security sensor and monitoring devices, and the like. Such appliances will require one or more of the following non-exhaustive list of construction items: electrical outlets, switch boxes, junctions or relays, plumbing supply pipes, drain pipes, built-in vacuum pipes and the like.

The scaled floor plans which include locations and measurements of appliances and fixtures, may be converted to the templates of the present invention either manually or automatically. The templates will show the locations or edges of various appliances or items. In a manual process, a user may make and mark the measurements in actual size on the template material. In an automated process, the template material may be fed into a printer, which advances the template material in a controlled manner while printing the necessary markings.

The template material is preferably a rollable or foldable material. Suitable rollable material may include a paper material, or plastic or fabric sheeting. Preferably, the material should be durable and resist tearing and stretching. A particularly suitable material may comprise Tyvek® (DuPont, U.S.A.) which is a non-woven sheet of high-density polyethylene fibres. The markings are preferably made in permanent ink, in a highly contrasting colour, such as black on white. Rigid materials may be used if the material is hinged so as to allow the template to be folded up.

Although the actual dimensions are not material, the templates provide actual size information. The horizontal template may be as long as a horizontal room dimension, for example 3 to 20 feet long or longer, but need not be floor to ceiling height. In one embodiment, the horizontal template is between about 1″ to about 18″ in height. In one embodiment, narrower templates may present fewer obstructions to workers.

The vertical template is preferably tall enough to show the highest necessary marking if the bottom of the template is installed level with the floor, or the lowest necessary marking if the top of the template is installed level with the ceiling. The vertical template is preferably of similar width to a wall stud, such as about 2″ wide. As the vertical template may only be 6-8 ft. long, it may be a rod or plank of rigid material and still be conveniently transported and used.

The horizontal or vertical templates may be attached to a wall frame comprising of metal or wood studs by any suitable method such as with a fastener or adhesive. In one embodiment, screws or nails may be used to attach the template to the studs. Alternatively, if the studs are steel studs, magnets may be used. What is important is that the template may be conveniently attached in sufficiently permanent manner so as not to be moved accidently during construction, but still be conveniently removed when finished. The vertical template may be moved from stud to stud as needed as construction proceeds.

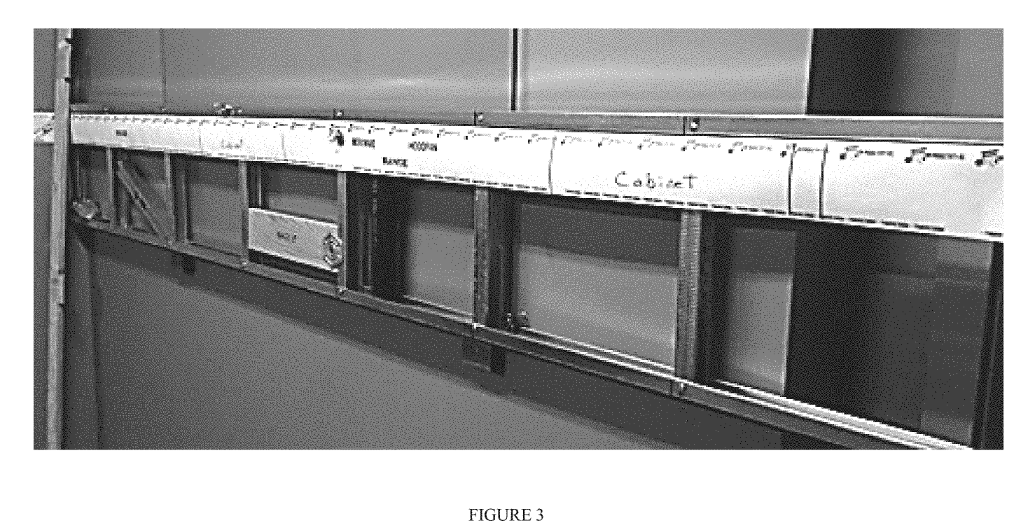

One example, of a horizontal template is shown in FIG. 3 on a model wall frame (where the vertical studs are shortened). A screw is used to attach the template at both ends, and near the centre.

Once installed, the templates will show exactly the planned location of various appliances and fixtures. A tradesperson may then confidently install the required construction items in the desired locations. The templates may also provide other jobsite specific information. The additional information may include safety information, contact information, identification of the contractor and subcontractors, written or visual details from the plans such as an image of the room layout or elevation may be provided, or any other information useful to a construction worker.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

1. An actual size construction template configured to attach across a plurality of studs in a wall frame, and which is marked with at least one construction location.

2. The template of claim 1 which comprises a rollable or foldable material.

3. The template of claim 2 which comprises paper, plastic or fabric sheeting.

4. The template of claim 1 wherein the template is produced from a scaled construction drawing.

5. The template of claim 1 wherein the at least one construction location indicates the installed location of an appliance or a fixture.

6. The template of claim 1 which is marked manually or with a printer.

7. A construction template kit comprising the template of claim 1 and an actual size vertical template configured to be attached to a stud vertically, and which is marked with at least one construction location.

8. The kit of claim 7 wherein the vertical template comprises a story rod or a rollable or foldable material.

9. A method of construction, comprising the steps of:
(a) producing an actual size template having at least one construction location marking;
(b) attaching the template to a wall frame after framing is complete but before wall finishings are attached.

10. The method of claim 9 wherein the template is a horizontal template configured to be attached across a plurality of wall studs.

11. The method of claim 10 further comprising the use of a vertical template configured to be attached on a vertical wall stud.

12. The method of claim 10 wherein the horizontal template comprises a rollable or foldable material.

13. The method of claim 12 wherein the horizontal template comprises paper, plastic or fabric sheeting.

14. The method of claim 9 wherein the at least one construction location indicates the installed location of an appliances or a fixture.
